(19) United States
(12) Patent Application Publication
(10) Pub. No.: US 2019/0377948 A1
(43) Pub. Date: Dec. 12, 2019

(54) METHOD FOR PROVIDING eXtended Reality CONTENT BY USING SMART DEVICE

(71) Applicant: LG ELECTRONICS INC., Seoul (KR)

(72) Inventors: Eunkoo LEE, Seoul (KR); Kihyung LEE, Seoul (KR)

(21) Appl. No.: 16/545,582

(22) Filed: Aug. 20, 2019

(30) Foreign Application Priority Data
Jun. 24, 2019 (KR) 10-2019-0075146

(51) Int. Cl. G06K 9/00; G06F 3/01; G06T 7/70; H04W 4/48

(52) U.S. Cl. CPC G06K 9/00671; G06K 9/00597; G06F 3/013; G06T 2207/20081; H04W 4/48; G06T 2207/30252; G06T 7/70

(57) ABSTRACT

Disclosed is a method of providing XR content using a smart device, the method including receiving state information of a vehicle driver from a sensor located on a front side of the smart device, receiving a first image of an external environment of a vehicle from a sensor located on a rear side of the smart device, generating an extended reality (XR) item based on the state information of the vehicle driver, and outputting XR content including a second image in which the generated XR item is displayed on the first image. One or more of an autonomous vehicle, a first terminal, a second terminal, and a server disclosed here is connectable to, for example, an artificial intelligence module, an unmanned aerial vehicle (UAV), a robot, an augmented reality (AR) device, a virtual reality (VR) device, or a 5G service device.

### CROSS-REFERENCE TO RELATED APPLICATION

This application is based on and claims priority under 35 U.S.C. § 119(a) to Korean Patent Application No. 10-2019-0075146, which was filed on Jun. 24, 2019 in the Korean Intellectual Property Office, the disclosure of which is incorporated herein in its entirety by reference.

### BACKGROUND

### 1. Field

The present disclosure relates to a method of providing a vehicle driver with eXtended Reality (XR) content using a smart device and a smart device for the same.

### 2. Description of the Related Art

A vehicle is a transportation means having an internal combustion engine, and may include not only an automobile but also a train and a motorcycle, for example. Meanwhile, various pieces of XR content may be provided for a vehicle driver. To provide XR content, a sensor that monitors the external environment of the vehicle driver and the vehicle and a device that generates XR content are additionally required. Thereby, there is a restriction in providing the vehicle driver with XR content.

Meanwhile, XR content is content that may provide a user with a new experience beyond the limit of reality, and a research for convergence of XR content with various fields is being conducted.

### SUMMARY

The foregoing summary is illustrative only and is not intended to be in any way limiting. In addition to the illustrative aspects, embodiments, and features described above, further aspects, embodiments, and features will become apparent by reference to the drawings and the following detailed description.

Embodiments disclosed here are intended to provide a method of providing a vehicle driver with XR content using a smart device and a smart device for the same. Technical subjects to be achieved by the embodiments are not limited to the aforementioned technical subjects, and other technical subjects may be deduced from the following embodiments.

According to one embodiment, a method of providing XR content using a smart device includes receiving state information of a vehicle driver from a sensor located on a front side of the smart device, receiving a first image of an external environment of a vehicle from a sensor located on a rear side of the smart device, generating an extended reality (XR) item based on the state information of the vehicle driver, and outputting XR content including a second image in which the generated XR item is displayed on the first image.

According to another embodiment, a smart device includes a processor configured to receive state information of a vehicle driver from a sensor located on a front side of the smart device, to receive a first image of an external environment of a vehicle from a sensor located on a rear side of the smart device, to generate an XR item based on the state information of the vehicle driver, and to output XR content including a second image in which the generated XR item is displayed on the first image, a memory configured to store at least one of the state information of the vehicle driver, the first image, the XR item, the second image, and the XR content, and a communication unit connected to the processor to perform transmission and reception of a signal between the vehicle and the processor.

Details of other embodiments are included in the detailed description and the drawings.

Embodiments of the present disclosure provide one or more of the following effects.

First, since a vehicle display and a smart device are used to provide a vehicle driver with XR content, it is possible to provide the vehicle driver with XR content without providing an additional device in a vehicle.

Second, since the attribute of a provided XR item may be changed according to state information of a vehicle driver, it is possible to provide the vehicle driver with personalized XR content.

Third, XR content, which is generated based on information input via a smart device, may also be provided via a vehicle display, which may improve convenience for a vehicle driver.

Fourth, as a result of acquiring a first image via a wide-angle lens when the driver's gaze is directed to a first side, it is possible to confirm the external situation of a vehicle, which was not seen by a previous first image, which may further enhance driving safety.

Effects of the present disclosure are not limited to the effects mentioned above, and other unmentioned effects may be clearly understood by those skilled in the art from a description of the claims.

### BRIEF DESCRIPTION OF THE DRAWINGS

The above and other aspects, features, and advantages of certain embodiments will be more apparent from the following detailed description taken in conjunction with the accompanying drawings, in which:

FIG. 1 illustrates an AI device 100 according to an embodiment of the present disclosure.

FIG. 2 illustrates an AI server 200 according to an embodiment of the present disclosure.

FIG. 3 illustrates an AI system 1 according to an embodiment of the present disclosure.

FIG. 4 is a view illustrating an example of a method of providing XR content using a smart device according to one embodiment of the present disclosure.

FIG. 5 is a view illustrating an example of a method of providing XR content using a smart device according to another embodiment of the present disclosure.

FIG. 6 is a view illustrating an example of generating an XR item based on state information of a vehicle driver according to one embodiment of the present disclosure.

FIG. 7 is a view illustrating an example of changing the attribute of an XR item based on state information of a vehicle driver according to another embodiment of the present disclosure.

FIG. 8 is a view illustrating an example of selecting a lens that acquires a first image based on the vehicle driver's gaze according to an embodiment of the present disclosure.

FIG. 9 is a view illustrating an example of outputting an XR item in response to an input by a vehicle driver according to an embodiment of the present disclosure.

FIGS. 10A and 10B is a view illustrating an example of XR content provided by a smart device according to an embodiment of the present disclosure.

FIG. 11 is a block diagram of a smart device according to an embodiment of the present disclosure.

FIG. 12 is a view illustrating an interworking relationship between a smart device and an external device according to an embodiment of the present disclosure.

FIG. 13 is a flowchart illustrating a method of providing XR content using a smart device according to one embodiment of the present disclosure.

FIG. 14 is a flowchart illustrating a method of providing XR content using a smart device according to another embodiment of the present disclosure.

FIG. 15 is a flowchart illustrating a method of providing XR content using a smart device according to a further embodiment of the present disclosure.

### DETAILED DESCRIPTION

In the following detailed description, reference is made to the accompanying drawing, which form a part hereof. The illustrative embodiments described in the detailed description, drawing, and claims are not meant to be limiting. Other embodiments may be utilized, and other changes may be made, without departing from the spirit or scope of the subject matter presented here.

Reference will now be made in detail to the embodiments of the present disclosure, examples of which are illustrated in the accompanying drawings, to allow those skilled in the art to easily understand and reproduce the embodiments of the present disclosure. The present disclosure, however, are not limited to the embodiments disclosed hereinafter and may be embodied in many different forms. In the drawings, to clearly and briefly explain the present disclosure, illustration of elements having no connection with the description is omitted, and the same or extremely similar elements are designated by the same reference numerals throughout the specification.

In the whole content of this specification, it will be understood that, when any element is referred to as being “connected to” another element, it may be directly connected to the other element or may be “electrically connected” to the other element with elements interposed therebetween. It will be further understood that the term “comprises” “comprising” “includes” and/or “including” when used in this specification, specify the presence of elements, but do not preclude the presence or addition of one or more other elements, unless the context clearly indicates otherwise.

In addition, “artificial Intelligence (AL)” refers to the field of studying artificial intelligence or a methodology capable of making the artificial intelligence, and “machine learning” refers to the field of studying methodologies that define and solve various problems handled in the field of artificial intelligence. The machine learning is also defined as an algorithm that enhances performance for a certain operation through a steady experience with respect to the operation.

An “artificial neural network (ANN)” may refer to a general model for use in the machine learning, which is composed of artificial neurons (nodes) forming a network by synaptic connection and has problem solving ability. The artificial neural network may be defined by a connection pattern between neurons of different layers, a learning process of updating model parameters, and an activation function of generating an output value.

The artificial neural network may include an input layer and an output layer, and may selectively include one or more hidden layers. Each layer may include one or more neurons, and the artificial neural network may include a synapse that interconnects neurons. In the artificial neural network, each neuron may output the value of an activation function concerning signals input through the synapse, weights, and deflection thereof.

The model parameters refer to parameters determined by learning, and include weights for synaptic connection and deflection of neurons, for example. Then, hyper-parameters refer to parameters to be set before learning in a machine learning algorithm, and include a learning rate, the number of repetitions, the size of a mini-batch, and an initialization function, for example.

It can be said that the purpose of learning of the artificial neural network is to determine a model parameter that minimizes a loss function. The loss function may be used as an index for determining an optimal model parameter in a learning process of the artificial neural network.

The machine learning may be classified, according to a learning method, into supervised learning, unsupervised learning, and reinforcement learning.

The supervised learning refers to a learning method for an artificial neural network in the state in which a label for learning data is given. The label may refer to a correct answer (or a result value) to be deduced by the artificial neural network when learning data is input to the artificial neural network. The unsupervised learning may refer to a learning method for the artificial neural network in the state in which no label for learning data is given. The reinforcement learning may refer to a learning method in which an agent defined in a certain environment learns to select a behavior or a behavior sequence that maximizes cumulative compensation in each state.

The machine learning realized by a deep neural network (DNN) including multiple hidden layers among artificial neural networks is also called deep learning, and the deep learning is a part of the machine learning. In the following description, the machine learning is used as a meaning including the deep learning.

“Autonomous driving” refers to a technology in which a vehicle drives autonomously, and the term “autonomous vehicle” refers to a vehicle that travels without a user's operation or with a user's minimum operation.

For example, autonomous driving may include all of the technology of maintaining the lane in which a vehicle is driving, the technology of automatically adjusting a vehicle speed such as adaptive cruise control, the technology of causing a vehicle to automatically drive along a given route, and the technology of automatically setting a route, along which a vehicle drives, when a destination is set.

Here, the vehicle may include all of a vehicle having only an internal combustion engine, a hybrid vehicle having both an internal combustion engine and an electric motor, and an electric vehicle having only an electric motor, and may include not only an automobile but also a train and a motorcycle, for example.

At this time, the autonomous vehicle may be seen as a robot having an autonomous driving function.

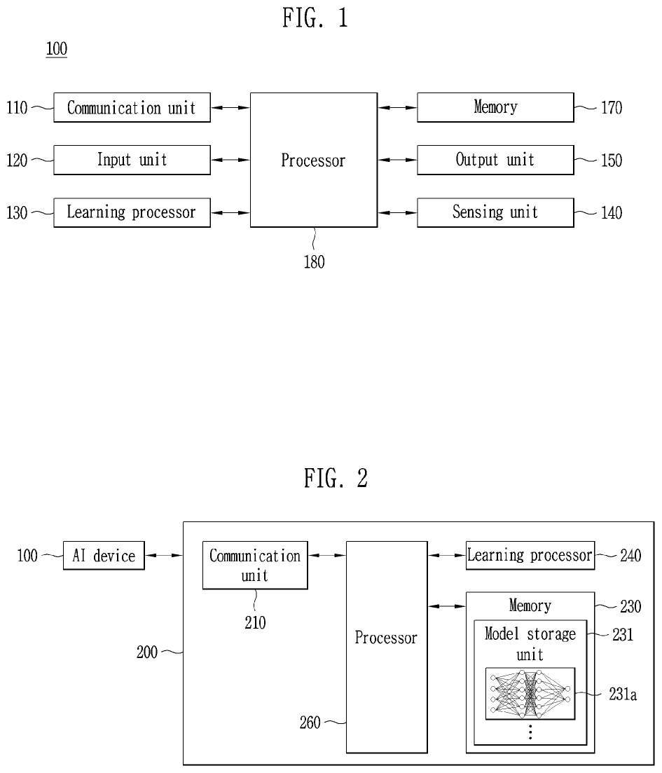

FIG. 1 illustrates AI device 100 according to an embodiment of the present disclosure.

AI device 100 may be realized into, for example, a stationary appliance or a movable appliance, such as a TV, a projector, a cellular phone, a smart phone, a desktop computer, a laptop computer, a digital broadcasting terminal, a personal digital assistant (PDA), a portable multimedia player (PMP), a navigation system, a tablet PC, a wearable device, a set-top box (STB), a refrigerator, a digital signage, a robot, a vehicle, or an XR device.

Referring to FIG. 1, AI device 100 may include a communication unit 110, an input unit 120, a learning processor 130, a sensing unit 140, an output unit 150, a memory 170, and a processor 180, for example. However, all of the components illustrated in FIG. 1 may not be essential components of AI device 100. The AI device may be implemented by a greater or lesser number of components than the components illustrated in FIG. 1.

Communication unit 110 may transmit and receive data to and from external devices, such as other AI devices 100a to 100e and an AI server 200, using wired/wireless communication technologies. For example, communication unit 110 may transmit and receive sensor information, user input, learning models, and control signals, for example, to and from external devices.

At this time, the communication technology used by communication unit 110 may be, for example, a global system for mobile communication (GSM), code division multiple Access (CDMA), long term evolution (LTE), 5G, wireless LAN (WLAN), wireless-fidelity (Wi-Fi), bluetooth™, radio frequency identification (RFID), infrared data association (IrDA), ZigBee, or near field communication (NFC).

Input unit 120 may acquire various types of data.

At this time, input unit 120 may include a camera for the input of an image signal, a microphone for receiving an audio signal, and a user input unit for receiving information input by a user, for example. Here, the camera or the microphone may be handled as a sensor, and a signal acquired from the camera or the microphone may be referred to as sensing data or sensor information.

Input unit 120 may acquire, for example, input data to be used when acquiring an output using learning data for model learning and a learning model. Input unit 120 may acquire unprocessed input data, and in this case, processor 180 or learning processor 130 may extract an input feature as pre-processing for the input data.

Learning processor 130 may cause a model configured with an artificial neural network to learn using the learning data. Here, the learned artificial neural network may be called a learning model. The learning model may be used to deduce a result value for newly input data other than the learning data, and the deduced value may be used as a determination base for performing any operation.

At this time, learning processor 130 may perform AI processing along with a learning processor 240 of AI server 200.

At this time, learning processor 130 may include a memory integrated or embodied in AI device 100. Alternatively, learning processor 130 may be realized using memory 170, an external memory directly coupled to AI device 100, or a memory held in an external device.

Sensing unit 140 may acquire at least one of internal information of AI device 100 and surrounding environmental information and user information of AI device 100 using various sensors.

At this time, the sensors included in sensing unit 140 may be a proximity sensor, an illuminance sensor, an acceleration sensor, a magnetic sensor, a gyro sensor, an inertial sensor, an RGB sensor, an IR sensor, a fingerprint recognition sensor, an ultrasonic sensor, an optical sensor, a microphone, a lidar, and a radar, for example.

Output unit 150 may generate, for example, a visual output, an auditory output, or a tactile output.

At this time, output unit 150 may include, for example, a display that outputs visual information, a speaker that outputs auditory information, and a haptic module that outputs tactile information.

Memory 170 may store data which assists various functions of AI device 100. For example, memory 170 may store input data acquired by input unit 120, learning data, learning models, and learning history, for example. Memory 170 may include a storage medium of at least one type among a flash memory, a hard disk, a multimedia card micro type memory, a card type memory (e.g., SD or XD memory), a random access memory (RAM) a static random access memory (SRAM), a read only memory (ROM), an electrically erasable programmable read-only memory (EEPROM), a programmable read-only memory (PROM), a magnetic memory, a magnetic disc, and an optical disc.

Processor 180 may determine at least one executable operation of AI device 100 based on information determined or generated using a data analysis algorithm or a machine learning algorithm. Then, processor 180 may control constituent elements of AI device 100 to perform the determined operation.

To this end, processor 180 may request, search, receive, or utilize data of learning processor 130 or memory 170, and may control the constituent elements of AI device 100 so as to execute a predictable operation or an operation that is deemed desirable among the at least one executable operation.

At this time, when connection of an external device is necessary to perform the determined operation, processor 180 may generate a control signal for controlling the external device and may transmit the generated control signal to the external device.

Processor 180 may acquire intention information with respect to user input and may determine a user request based on the acquired intention information.

At this time, processor 180 may acquire intention information corresponding to the user input using at least one of a speech to text (STT) engine for converting voice input into a character string and a natural language processing (NLP) engine for acquiring natural language intention information.

At this time, at least a part of the STT engine and/or the NLP engine may be configured with an artificial neural network learned according to a machine learning algorithm. Then, the STT engine and/or the NLP engine may have learned by learning processor 130, may have learned by learning processor 240 of AI server 200, or may have learned by distributed processing of processors 130 and 240.

Processor 180 may collect history information including, for example, the content of an operation of AI device 100 or feedback of the user with respect to an operation, and may store the collected information in memory 170 or learning processor 130, or may transmit the collected information to an external device such as AI server 200. The collected history information may be used to update a learning model.

Processor 180 may control at least some of the constituent elements of AI device 100 in order to drive an application program stored in memory 170. Moreover, processor 180 may combine and operate two or more of the constituent elements of AI device 100 for the driving of the application program.

FIG. 2 illustrates AI server 200 according to an embodiment of the present disclosure.

Referring to FIG. 2, AI server 200 may refer to a device that causes an artificial neural network to learn using a machine learning algorithm or uses the learned artificial neural network. Here, AI server 200 may be constituted of multiple servers to perform distributed processing, and may be defined as a 5G network. At this time, AI server 200 may be included as a constituent element of AI device 100 so as to perform at least a part of AI processing together with AI device 100.

AI server 200 may include a communication unit 210, a memory 230, a learning processor 240, and a processor 260, for example.

Communication unit 210 may transmit and receive data to and from an external device such as AI device 100.

Memory 230 may include a model storage unit 231. Model storage unit 231 may store a model (or an artificial neural network) 231a which is learning or has learned via learning processor 240.

Learning processor 240 may cause artificial neural network 231a to learn learning data. A learning model may be used in the state of being mounted in AI server 200 of the artificial neural network, or may be used in the state of being mounted in an external device such as AI device 100.

The learning model may be realized in hardware, software, or a combination of hardware and software. In the case in which a part or the entirety of the learning model is realized in software, one or more instructions constituting the learning model may be stored in memory 230.

Processor 260 may deduce a result value for newly input data using the learning model, and may generate a response or a control instruction based on the deduced result value.

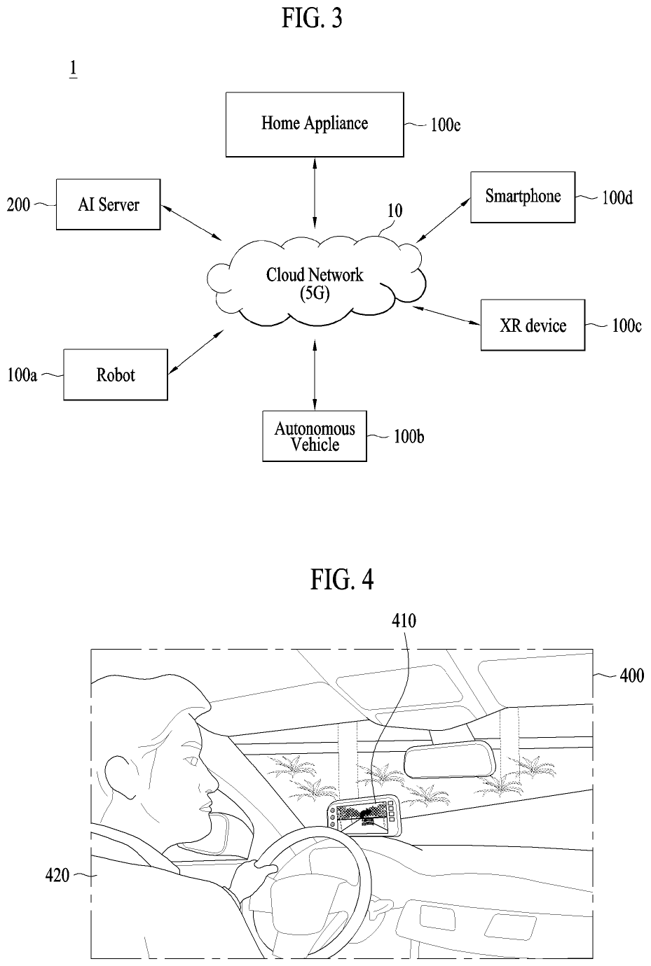

FIG. 3 illustrates AI system 1 according to an embodiment of the present disclosure.

Referring to FIG. 3, in AI system 1, at least one of AI server 200, a robot 100a, an autonomous vehicle 100b, an XR device 100c, a smart phone 100d, and a home appliance 100e is connected to a cloud network 10. Here, robot 100a, autonomous vehicle 100b, XR device 100c, smart phone 100d, and home appliance 100e, to which AI technologies are applied, may be referred to as AI devices 100a to 100e.

Cloud network 10 may constitute a part of a cloud computing infra-structure, or may mean a network present in the cloud computing infra-structure. Here, cloud network 10 may be configured using a 3G network, a 4G or long term evolution (LTE) network, or a 5G network, for example.

That is, respective devices 100a to 100e and 200 constituting AI system 1 may be connected to each other via cloud network 10. In particular, respective devices 100a to 100e and 200 may communicate with each other via a base station, or may perform direct communication without the base station.

AI server 200 may include a server which performs AI processing and a server which performs an operation with respect to big data.

AI server 200 may be connected to at least one of robot 100a, autonomous vehicle 100b, XR device 100c, smart phone 100d, and home appliance 100e, which are AI devices constituting AI system 1, via cloud network 10, and may assist at least a part of AI processing of connected AI devices 100a to 100e.

At this time, instead of AI devices 100a to 100e, AI server 200 may cause an artificial neural network to learn according to a machine learning algorithm, and may directly store a learning model or may transmit the learning model to AI devices 100a to 100e.

At this time, AI server 200 may receive input data from AI devices 100a to 100e, may deduce a result value for the received input data using the learning model, and may generate a response or a control instruction based on the deduced result value to transmit the response or the control instruction to AI devices 100a to 100e.

Alternatively, AI devices 100a to 100e may directly deduce a result value with respect to input data using the learning model, and may generate a response or a control instruction based on the deduced result value.

Hereinafter, various embodiments of AI devices 100a to 100e, to which the above-described technology is applied, will be described. Here, AI devices 100a to 100e illustrated in FIG. 3 may be specific embodiments of AI device 100 illustrated in FIG. 1.

XR device 100c according to the present embodiment may be realized into a head-mount display (HMD), a head-up display (HUD) provided in a vehicle, a television, a cellular phone, a smart phone, a computer, a wearable device, a home appliance, a digital signage, a vehicle, a stationary robot, or a mobile robot, for example, through the application of AI technologies.

XR device 100c may obtain information on the surrounding space or a real object by analyzing three-dimensional point cloud data or image data acquired from various sensors or an external device to generate positional data and attribute data for three-dimensional points, and may output an XR object by rendering the XR object to be output. For example, XR device 100c may output an XR object including additional information about a recognized object so as to correspond to the recognized object.

XR device 100c may perform the above-described operations using a learning model configured with at least one artificial neural network. For example, XR device 100c may recognize a real object from three-dimensional point cloud data or image data using a learning model, and may provide information corresponding to the recognized real object. Here, the learning model may be directly learned in XR device 100c, or may be learned in an external device such as AI server 200.

At this time, XR device 100c may directly generate a result using the learning model to perform an operation, but may transmit sensor information to an external device such as AI server 200 and receive the generated result to perform an operation.

In addition, an XR device according to another embodiment may be one component of an autonomous vehicle. In other words, autonomous vehicle 100b may be realized into a mobile robot, a vehicle, or an unmanned air vehicle, for example, through the application of AI technologies.

Autonomous vehicle 100b, to which the XR technologies are applied, may refer to an autonomous vehicle having an XR image providing device, or may refer to an autonomous vehicle as a control or interaction target in an XR image, for example. Particularly, autonomous vehicle 100b as a control or interaction target in an XR image may be provided separately from XR device 100c and may operate in cooperation with XR device 100c.

Autonomous vehicle 100b having the XR image providing device may acquire sensor information from sensors including a camera, and may output an XR image generated based on the acquired sensor information. For example, autonomous vehicle 100b may include an HUD to output an XR image, thereby providing an occupant with an XR object corresponding to a real object or an object in the screen.

At this time, when the XR object is output to the HUD, at least a portion of the XR object may be output so as to overlap with a real object to which the passenger's gaze is directed. On the other hand, when the XR object is output to a display provided in autonomous vehicle 100b, at least a portion of the XR object may be output so as to overlap with an object in the screen. For example, autonomous vehicle 100b may output XR objects corresponding to objects such as a lane, another vehicle, a traffic light, a traffic sign, a two-wheeled vehicle, a pedestrian, and a building.

When autonomous vehicle 100b as a control or interaction target in an XR image acquires sensor information from sensors including a camera, autonomous vehicle 100b or XR device 100c may generate an XR image based on the sensor information, and XR device 100c may output the generated XR image. Then, autonomous vehicle 100b may operate based on a control signal input through an external device such as XR device 100c or via interaction with the user.

A smart device according to an embodiment of the present disclosure is one example of XR device 100c of FIG. 3 and is capable of generating an XR image and outputting the generated XR image via at least one of the smart device and a vehicle display.

FIG. 4 is a view illustrating an example of a method of providing XR content using a smart device according to one embodiment of the present disclosure.

Referring to FIG. 4, a smart device 410 may be disposed on the front side of a vehicle 400 within the visual field of a driver 420. In this case, smart device 410 may acquire state information of driver 420 via a sensor on the front side, and may acquire an image of the external environment of the vehicle via a sensor on the rear side. Thus, smart device 410 may generate an XR item based on the state information of driver 420, and may generate XR content indicating the XR item on the acquired image of the external environment. Thereafter, the XR content generated by smart device 410 may be provided to driver 420 via smart device 410, or may be provided to driver 420 via a display of vehicle 400. Accordingly, the XR content may be provided to driver 420 inside vehicle 400 via smart device 410 without an additional device provided in vehicle 400.

Here, smart device 410 may be a smart phone, a tablet PC, a mobile phone, a personal digital assistant (PDA), a laptop computer, or any other mobile computing device, without a limitation thereto. In addition, a mobile device may be a wearable device, such as a watch, glasses, a hair band, or a ring, which has a communication function and a data processing function. In addition, smart device 410 may be any one of AI device 100 of FIG. 1.

In addition, smart device 410 of FIG. 4 includes a display on the front side thereof, but it will be apparent to those skilled in the art that a device having no display may also be used as the smart device according to an embodiment of the present disclosure.

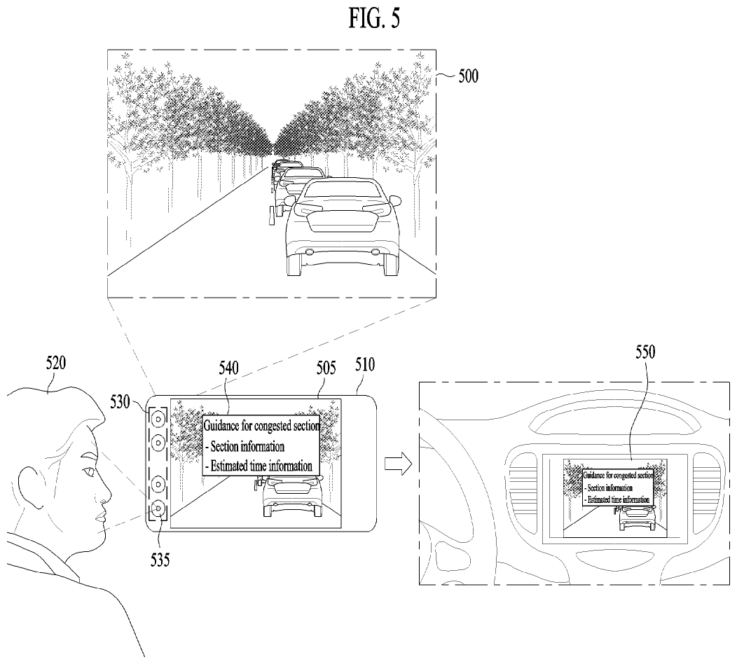

FIG. 5 is a view illustrating an example of a method of providing XR content using a smart device according to another embodiment of the present disclosure.

The smart device according to an embodiment of the present disclosure may generate an XR item indicating traffic information of a road on which a vehicle is currently located. To this end, the smart device may receive the traffic information from an external network.

Referring to FIG. 5, a smart device 510 may include multiple sensors 530 on the front side thereof, and may acquire state information of a driver 520 using one sensor 535 among the multiple sensors 530 on the front side. For example, the state information of driver 520 may be acquired by photographing driver 520 using one sensor 535 among the sensors on the front side of smart device 510 and then tracking the pupils of driver 520 using the captured image. In addition, smart device 510 may acquire a first image 500 of the external environment of the vehicle via a sensor on the rear side thereof.

When it is determined from the state information of driver 520 that driver 520 gazes at the road ahead and when the road ahead is congested, smart device 510 may receive traffic information of the road from an external network and may generate an XR item 540 based on the received traffic information. In addition, smart device 510 may superimpose XR item 540 on first image 500. In this specification, an image in which XR item 540 is superimposed on first image 500 is defined as a second image. The second image may be one of various pieces of XR content. For example, the XR content provided by the smart device may include not only the second image but also vibration and sound.

In addition, smart device 510 may output the generated second image via at least one of a display 505 of smart device 510 and a display 550 of the vehicle. Thus, driver 520 may check the XR content via not only smart device 510 but also display 550 of the vehicle.

Meanwhile, FIG. 5 illustrates the embodiment in which the smart device acquires an image of driver 520 via one sensor 535 among the multiple sensors 530 on the front side thereof and then acquires the state information of driver 520 based on the acquired image, but the number and the kind of sensors on the front side and the rear side of the smart device according to an embodiment of the present disclosure are not limited thereto.

In addition, smart device 510 may acquire the state information of driver 520 by receiving sensing information from one of multiple sensors, or may acquire the state information of driver 520 based on combinations of various pieces of sensing information received from multiple sensors.

Meanwhile, FIG. 5 illustrates that the second image is displayed on display 550 of a vehicle navigation system, but a vehicle display on which the second image may be displayed is not limited thereto. For example, the second image may be displayed on at least one of a windshield, a window, and an HUD of the vehicle.

In addition, smart device 510 may further consider the internal environment of the vehicle in conjunction with the state information of driver 520 to generate an XR item. For example, when smart device 510 acquires driver state information indicating that driver 520 is sweating and receives information on the internal temperature of the vehicle, smart device 510 may generate an XR item that proposes to lower the internal temperature of the vehicle based on the acquired information. Meanwhile, the internal environment of the vehicle that may be considered when generating an XR item may include not only the temperature but also the humidity and illumination of a vehicle cabin, the position of the seat of driver 520, and the degree of noise, for example, without a limitation thereto.

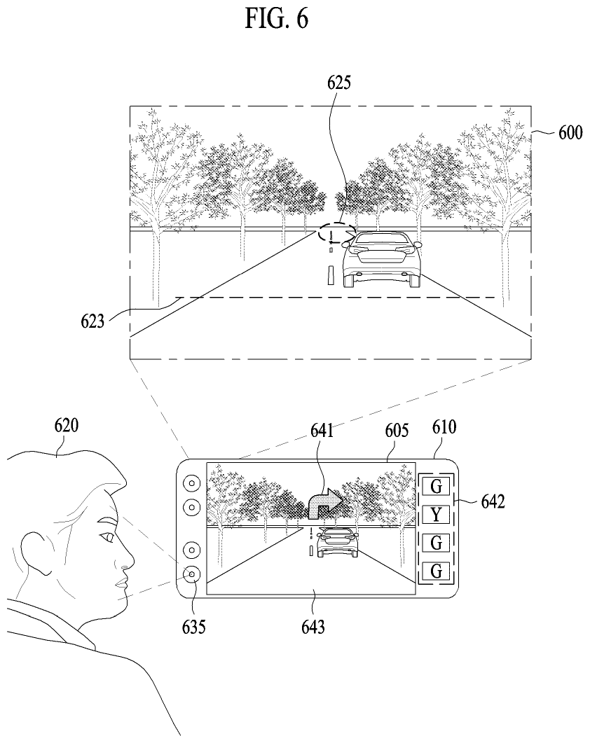

FIG. 6 is a view illustrating an example of generating an XR item based on state information of a vehicle driver according to one embodiment of the present disclosure.

According to an embodiment of the present disclosure, when an estimated driving route is input, the smart device may generate an XR item based on the input estimated driving route. Here, the estimated driving route may be input via a navigation function of the smart device, or may be received from the vehicle. In addition, the smart device may receive the estimated driving route from an external network.

Referring to FIG. 6, when it is determined based on the estimated driving route of the vehicle that the vehicle needs to make right turn soon, a smart device 610 may provide a driver 620 with a second image 605, in which a first XR item 641 indicating right turn is displayed, to allow the user to recognize the determined result.

In addition, smart device 610 may additionally display a second XR item 642 to allow driver 620 to easily distinguish the state of driver 620, the connection state between the vehicle and smart device 610, the road state, and the driving state, for example. In second XR item 642, an article in a normal state may be displayed in green G, an article requiring attention may be displayed in yellow Y, and an article requiring warning may be displayed in red R. However, for example, the state information indicated via second XR item 642 and the display form of second XR item 642 are not limited thereto.

In addition, according to an embodiment of the present disclosure, the smart device may determine whether or not the driver's gaze deviates from a normal driving range based on the state information of the driver.

For example, referring to FIG. 6, smart device 610 may determine whether or not a gaze 625 of the driver deviates from a normal driving range 623 based on a first image 600 acquired via a sensor on the rear side. Here, normal driving range 623 may refer to the range within which the gaze is located when driver 620 normally drives the vehicle. Normal driving range 623 may have a different value for each driver 620, and may have a fixed value which is stored in advance in smart device 610.

When gaze 625 of driver 620 deviates from normal driving range 623, smart device 610 may determine that driver 620 wants to be guided for next driving on the estimated driving route. Thus, smart device 610 may provide driver 620 with second image 605 in which first XR item 641 indicating guidance (right turn in the case of FIG. 6) for next driving is displayed.

Meanwhile, it has been described with reference to FIG. 6 that first XR item 641 indicating guidance for next driving is displayed on first image 600 only when gaze 625 of driver 620 deviates from normal driving range 623, but the smart device according to another embodiment may display the first XR item on the first image even when the driver's gaze is within the normal driving range.

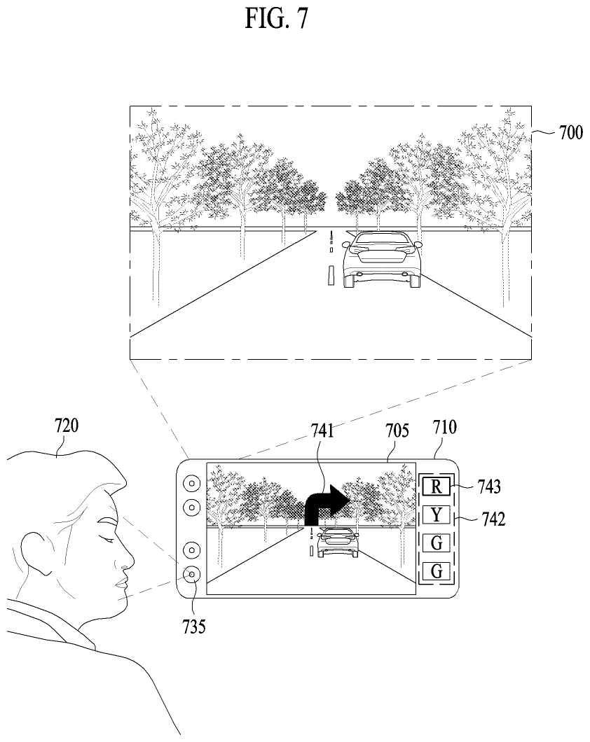

FIG. 7 is a view illustrating an example of changing the attribute of an XR item based on state information of a vehicle driver according to another embodiment of the present disclosure.

According to an embodiment of the present disclosure, the smart device may change the attribute of an XR item or may additionally generate warning content based on driver state information.

For example, as illustrated in FIG. 7, when a driver 720 drives while drowsy, a smart device 710 may recognize the situation in which driver 720 drowses based on state information of driver 720 acquired via a sensor 735 on the front side thereof. Specifically, smart device 710 may recognize that driver 720 drowses when failed to trace the pupils of driver 720, but it will be apparent to those skilled in the art that smart device 710 may acquire the state information of driver 720 based on other sensor information. For example, smart device 710 may determine whether or not driver 720 drowses based on information on the eye focus of driver 720.

Meanwhile, when it is determined that driver 720 drowses, smart device 710 may change the attributes of XR items 741 and 742. For example, smart device 710 may increase the size of first XR item 741 indicating guidance for next driving and may change the color of XR item 742 to red. In addition, the smart device may cause first XR item 741 to flicker and may change the position at which first XR item 741 is displayed, but the attribute of first XR item 741 to be changed are not limited thereto.

In addition, smart device 710 may additionally generate warning content, in addition to changing the attribute of first XR item 741. Here, warning content may include not only visual content but also, for example, audio content and tactile content which may call the attention of driver 720. For example, smart device 710 may display driver state information 743 in red R of second XR item 742, may output a warning sound signal, or may vibrate to call the attention of driver 720.

Moreover, to allow the vehicle to call the attention of driver 720, smart device 710 may output a signal to the vehicle to control the internal environment of the vehicle. For example, the smart device may lower a vehicle window to ventilate the vehicle cabin, may operate an air conditioner to lower the internal temperature of the vehicle, or may operate an aroma spray device to spray aroma so as to improve concentration of driver 720. In addition, the smart device may wake driver 720 up by shaking the seat of driver 720. However, the internal environment of the vehicle that may be controlled to call the attention of driver 720 is not limited thereto.

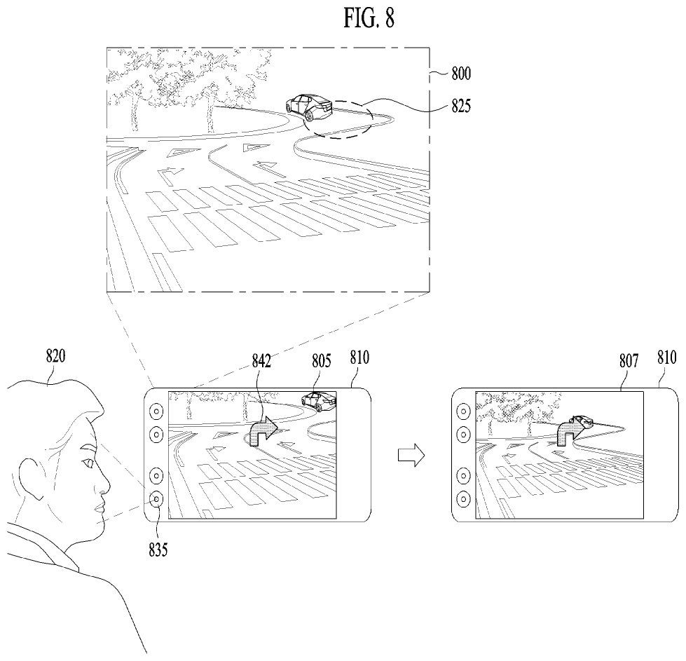

FIG. 8 is a view illustrating an example of selecting a lens that acquires a first image based on the vehicle driver's gaze according to an embodiment of the present disclosure.

According to an embodiment of the present disclosure, when it is determined that the driver's gaze is directed to a first side, the smart device may select a second lens as a sensor that acquires a first image from among multiple sensors arranged on the rear side thereof.

Referring to FIG. 8, a smart device 810 may determine whether or not a gaze 825 of a driver 820 is directed to a first side via a sensor 835 on the front side thereof. For example, when driver 820 tries to make right turn or when driver 820 gazes at an object on the right side of a road for a long time, smart device 810 may determine that gaze 825 of driver 820 is directed to the right side by tracing the pupils of driver 820.

When gaze 825 of driver 820 is directed to the right side, smart device 810 may change a lens that photographs a first image to a second lens which is a wide-angle lens so that a first image 807 within a wider visual field than a previous first image 805 may be acquired. Accordingly, since driver 820 may check the road situation, which was not seen from the previous first image, using newly acquired first image 807, driving safety may further be improved.

Meanwhile, multiple sensors arranged on the rear side and multiple sensors arranged on the front side may include, for example, a proximity lens, a general lens, a wide-angle lens, a distortion lens, an ultra-proximity lens, an ultra-wide-angle lens, and a zoom lens, and may further include, for example, an infrared sensor, an RGB sensor, a brightness sensor, a proximity sensor, and a temperature sensor.

Meanwhile, smart device 810 may select the lens that acquires the first image not only when the gaze of driver 820 is directed to the first side but also when the gaze of driver 820 is directed to the opposite end of the road or remains at one point for a long time. In this case, the selected lens may be a zoom lens or a proximity lens.

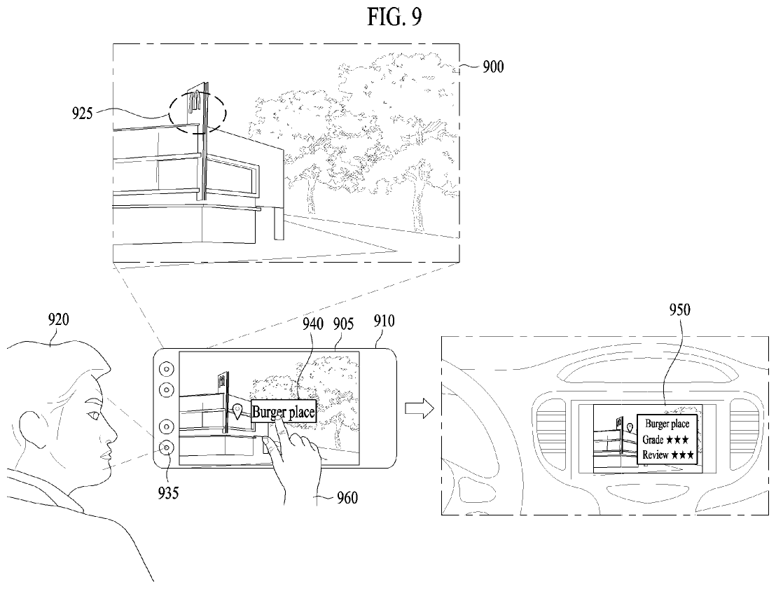

FIG. 9 is a view illustrating an example of outputting an XR item in response to an input of a vehicle driver according to an embodiment of the present disclosure.

According to an embodiment of the present disclosure, when an input by the driver is received from the smart device or the vehicle, the smart device may update an XR item based on the input by the driver, and may output a third image including the updated XR item to one of the smart device and the vehicle from which no input is received.

Referring to FIG. 9, a smart device 910 may determine that gaze 925 of driver 920 is directed to a first store via sensor 935 on the front side thereof. When the first store is a burger place, smart device 910 may generate a first XR item 940 indicating that the first store is a burger place and may output a second image 905 including XR item 940 to a display of smart device 910.

At this time, when driver 920 touches first XR item 940 displayed on smart device 910, smart device 910 may further output a second XR item indicating detailed information such as the grade of the burger place and a review about the burger place based on the touch input. In this case, smart device 910 may also cause a display 950 of the vehicle, which does not receive an input of driver 920, to display a third image in which the second XR item is displayed.

Meanwhile, it has been described that the first XR item of FIG. 9 is the name of the first store and the second XR item contains detailed information on the first store, but information indicated by the first XR item and the second XR item is not limited thereto.

In addition, FIG. 9 has been described under the assumption that the input by the driver is received via the smart device, but it will be apparent to those skilled in the art that the second XR item may be displayed on the smart device even when the input by the driver is received via the display of the vehicle.

In addition, in this specification, the touch input may include at least one of a gesture input, a click input, a double-click input, and a drag input, but the type of the touch input is not limited thereto.

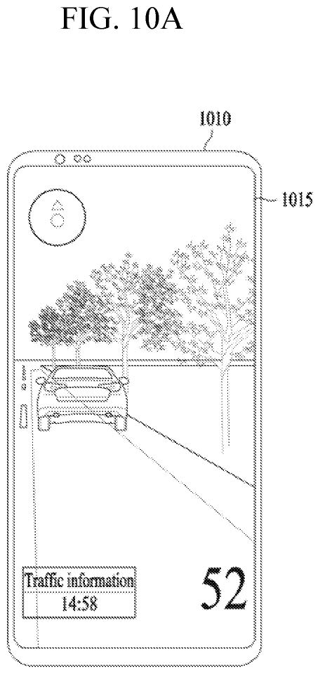

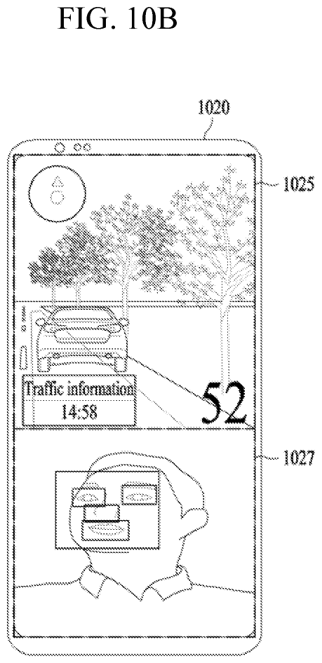

FIGS. 10A-10B is a view illustrating an example of XR content provided by a smart device according to an embodiment of the present disclosure.

Referring to (a) in FIG. 10, a smart device 1010 may display a second image 1015 including an XR item. Here, the XR item may include an estimated driving route, a current vehicle speed, a time, and a direction, for example, but the type of the XR item is not limited thereto. When an estimated driving route of the vehicle is not input to smart device 1010, smart device 1010 may generate an XR item regarding, for example, traffic information and information on famous restaurants around the road which are received from an external network.

In addition, the smart device may display a captured image of a driver along with a second image including an XR item. Referring to (b) in FIG. 10, a second image 1025 may be displayed on an upper region of a display of the smart device, and a captured image 1027 of the driver may be displayed on a lower region of the display. Meanwhile, since the captured image 1027 of the driver may show information indicating the tracking state of the pupils of the driver, the driver may check whether or not the smart device has difficulty in acquiring state information of the driver.

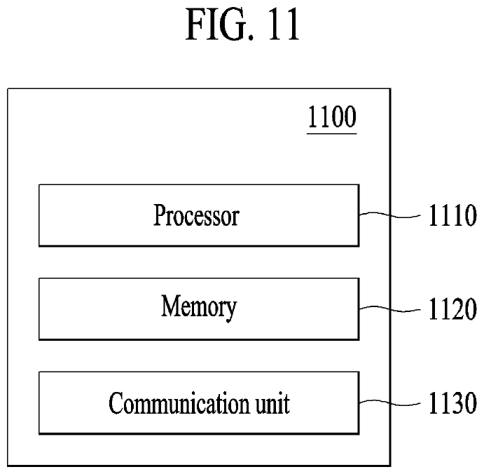

FIG. 11 is a block diagram of a smart device according to an embodiment of the present disclosure.

A smart device 1100 according to an embodiment of the present disclosure may include a processor 1110, a memory 1120, and a communication unit 1130.

Processor 1110 usually controls a general operation of smart device 1100. For example, processor 1110 may control communication unit 1130 and all other components of the vehicle by executing programs stored in memory 1120. In addition, processor 1110 may perform functions of the smart device described with reference to FIGS. 4 to 10 by executing programs stored in memory 1120.

In addition, processor 1110 may receive state information of a vehicle driver from a sensor located on the front side of the smart device, may receive a first image of the external environment of the vehicle from a sensor located on the rear side of the smart device, may generate an XR item based on the state information of the vehicle driver, and may output XR content including a second image in which the generated XR item is displayed on the first image.

Here, processor 1110 may output the second image to at least one of a display of smart device 1100 and a display of the vehicle.

Meanwhile, the state information of the vehicle driver may be information acquired by tracing the pupils of the vehicle driver.

In addition, when an estimated driving route of the vehicle is input, processor 1110 may generate an XR item based on the estimated driving route. Here, the estimated driving route of the vehicle may be information generated by the smart device or received from the vehicle.

In addition, when multiple sensors are arranged on the rear side of the smart device, prior to receiving the first image, processor 1110 may select a sensor that acquires the first image from among the multiple sensors based on the state information of the vehicle driver. Here, when selecting the sensor that acquires the first image, processor 1110 may determine whether or not the gaze of the vehicle driver is directed to a first side based on the state information of the vehicle driver, and may select a second lens as the sensor that acquires the first image from among the multiple sensors arranged on the rear side based on the determined result. Here, the second lens may be any one of a general lens, a wide-angle lens, a distortion lens, an ultra-proximity lens, an ultra-wide-angle lens, and a zoom lens.

In addition, processor 1110 may receive information on the internal environment of the vehicle from the vehicle, and may generate an XR item based on the received information on the internal environment of the vehicle.

In addition, when an input by the vehicle driver is received from smart device 1100 or the vehicle, processor 1110 may update an XR item based on the input by the driver, and may output a third image including the updated XR item to one of smart device 1100 and the vehicle from which no input is received.

In addition, processor 1110 may detect information on the eye focus of the vehicle driver based on the state information of the vehicle driver, and may change the attribute of the XR item or may additionally generate warning content based on the detected information on the eye focus of the vehicle driver.

Memory 1120 may store at least one of the state information of the vehicle driver, the first image, the XR item, the second image, and the XR content.

Communication unit 1130 may be connected to the processor to transmit and receive signal between the vehicle and the processor.

It will be apparent to those skilled in the art that other features and functions of processor 1010, memory 1020, and communication unit 1030 may correspond to those of processor 180, memory 170, and communication unit 110 of FIG. 1.

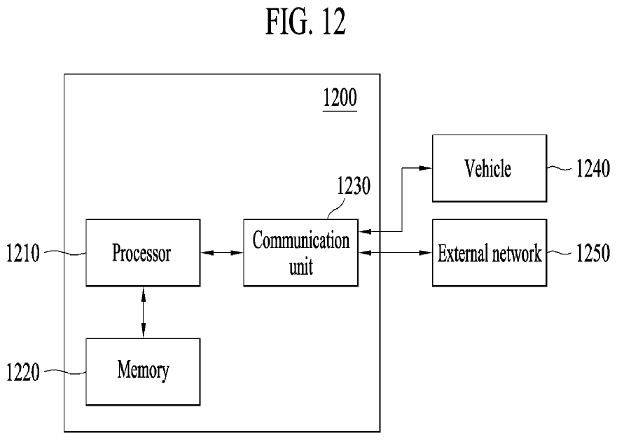

FIG. 12 is a view illustrating an interworking relationship between a smart device and an external device according to an embodiment of the present disclosure.

A smart device 1200 according to an embodiment of the present disclosure may interwork with a vehicle 1240 and an external network 1250.

Smart device 1200 may receive state information of a vehicle driver from a sensor of vehicle 1240, and may output XR content to a display of vehicle 1240. In addition, smart device 1200 may receive information on an estimated driving route from vehicle 1240. However, data that smart device 1200 may receive from vehicle 1240 is not limited thereto.

Meanwhile, the display of vehicle 1240 may include a plurality of display units attached to a windshield and a window of the vehicle and certain components of the vehicle. In addition, the display may include a transparent display which has predetermined transparency and displays content input from the smart device.

The transparent display may include at least one of a transparent thin film electroluminescent (TFEL) display, a transparent organic light emitting diode (OLED) display, a transparent liquid crystal display (LCD), a transparent transmissive display, and a transparent light emitting diode (LED) display in order to have desired transparency, and the transparency of the transparent display may be adjusted. In some embodiments, when the vehicle is not an autonomous vehicle, content displayed on a display located on the window of the vehicle may be provided with high transparency. In this way, the driver may grasp the peripheral environment along with XR content.

In addition, smart device 1200 may receive an XR item from external network 1250 or may receive information required for the generation of an XR item, but data that smart device 1200 may receive from external network 1250 is also not limited thereto.

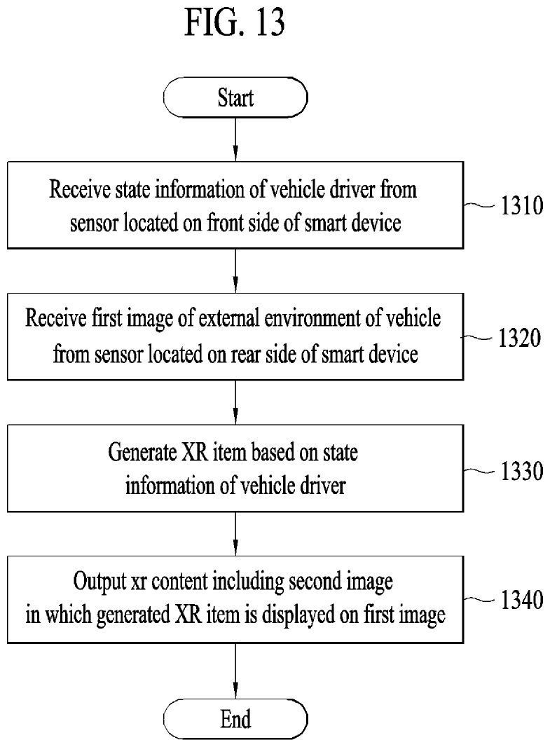

FIG. 13 is a flowchart illustrating a method of providing XR content using a smart device according to an embodiment of the present disclosure.

In step 1310, the smart device may receive state information of a vehicle driver from a sensor located on the front side of the smart device.

In step 1320, the smart device may receive a first image of the external environment of the vehicle from a sensor located on the rear side of the smart device.

When multiple sensors are arranged on the rear side of the smart device, step 1320 may include a step of selecting a sensor that acquires the first image from among the multiple sensors based on the state information of the vehicle driver. Here, the step of selecting the sensor that acquires the first image may include a step of determining whether or not the gaze of the vehicle driver is directed to a first side based on the state information of the vehicle driver and a step of selecting a second lens as the sensor that acquires the first image from among the multiple sensors arranged on the rear side of the smart device based on the determined result.

In step 1330, the smart device may generate an XR item based on the state information of the vehicle driver. When an estimated driving route of the vehicle is input, step 1330 may be a step of generating an XR item based on the estimated driving route. Here, the estimated driving route of the vehicle may be information generated by the smart device or received from the vehicle.

Alternatively, step 1330 may include a step of receiving information on the internal environment of the vehicle from the vehicle and a step of generating an XR item based on the received information on the internal environment of the vehicle.

In step 1340, the smart device may output XR content including a second image in which the generated XR item is displayed on the first image. Here, the second image may be output to at least one of a display of the smart device and a display of the vehicle.

Meanwhile, steps 1310 to 1340 of FIG. 13 may be repeatedly performed while the vehicle is driving.

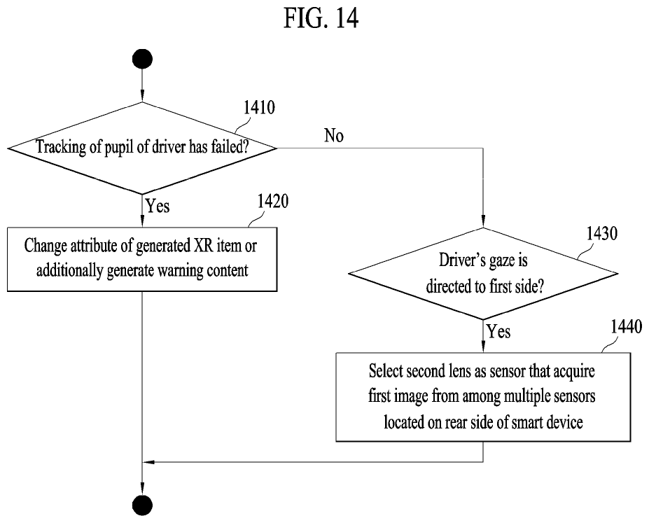

FIG. 14 is a flowchart illustrating a method of providing XR content using a smart device according to a further embodiment of the present disclosure.

In step 1410, the smart device may determine whether or not tracking of the pupils of the driver has failed based on state information of a vehicle driver. When tracking of the pupils of the driver has failed, step 1420 may be performed. When tracking of the pupils of the driver is not failed, step 1430 may be performed.

In step 1420, the smart device may change the attribute of an XR item or may additionally generate warning content. Here, the attribute of the XR item to be changed may include at least one of the size of the XR item, whether or not the XR item flickers, the color and the transparency of the XR item, and the position of the XR item on a second image. In addition, the additionally generated warning content may include all of visual content, audio content that may call the attention of the vehicle driver, and tactile content, for example.

In step 1430, the smart device may determine whether or not the driver's gaze is directed to a first side. When the driver's gaze is directed to the first side, step 1440 may be performed.

In step 1440, the smart device may select a second lens as a sensor that acquires a first image from among multiple sensors arranged on the rear side. Here, the second lens may be any one of a proximity lens, a general lens, a wide-angle lens, a distortion lens, an ultra-proximity lens, an ultra-wide-angle lens, and a zoom lens. When the smart device selects a wide-angle lens as the second lens, the road situation, which was not seen from a previous first image, may be checked via a first image which is newly acquired via the second lens, which may allow the vehicle driver to further safely perform driving.

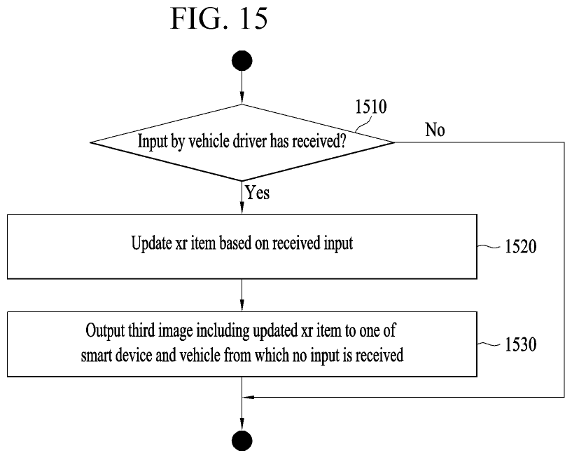

FIG. 15 is a flowchart illustrating a method of providing XR content using a smart device according to a further embodiment of the present disclosure.

In step 1510, the smart device may determine whether or not an input by the vehicle driver has been received. At this time, the input by the vehicle driver may be received from at least one of the smart device and the vehicle. When the input by the vehicle driver has been received, step 1520 may be performed. When the input by the vehicle driver has not been received, the method of FIG. 15 may terminate.

In step 1520, the smart device may update an XR item based on the input by the vehicle driver. For example, when the name of a store located near the road is displayed as an XR item and a touch input to the XR item by the vehicle driver is received, the smart device may further display an XR item including detailed information on the store.

In step 1530, the smart device may output a third image including the updated XR item to one of the smart device and the vehicle from which the input by the vehicle driver is not received. For example, when the driver's input is received via the display of the vehicle, the updated XR item may be output to the smart device. When the driver's input is received via the smart device, the updated XR item may be output to the display of the vehicle.

What is claimed is:

1. A method of providing XR content using a smart device, the method comprising:
receiving state information of a vehicle driver from a sensor located on a front side of the smart device;
receiving a first image of an external environment of a vehicle from a sensor located on a rear side of the smart device;
generating an extended reality (XR) item based on the state information of the vehicle driver; and
outputting XR content including a second image in which the generated XR item is displayed on the first image.

2. The method of claim 1, wherein the generating includes generating the XR item based on an estimated driving route of the vehicle when the estimated driving route is input, and
wherein the estimated driving route of the vehicle is generated by the smart device or is received from the vehicle.

3. The method of claim 1, wherein the receiving the first image includes selecting a sensor that acquires the first image from among a plurality of sensors based on the state information of the vehicle driver when the sensor located on the rear side of the smart device is provided in a plural number.

4. The method of claim 3, wherein the selecting includes:
determining whether or not a gaze of the vehicle driver is directed to a first side based on the state information of the vehicle driver; and
selecting a second lens as the sensor that acquires the first image from among the plurality of sensors located on the rear side of the smart device based on a result of the determining.

5. The method of claim 1, wherein the generating includes:
receiving information on an internal environment of the vehicle from the vehicle; and
generating the XR item based on the received information on the internal environment of the vehicle.

6. The method of claim 1, wherein the outputting includes outputting the second image to at least one of a display of the smart device and a display of the vehicle.

7. The method of claim 6, further comprising:
updating the XR item based on an input by the vehicle driver when the input by the vehicle driver is received from the smart device or the vehicle; and
outputting a third image including the updated XR item to one of the smart device and the vehicle from which no input is received.

8. The method of claim 1, wherein the state information of the vehicle driver is information acquired by tracing pupils of the vehicle driver.

9. The method of claim 1, further comprising:
detecting information on an eye focus of the vehicle driver based on the state information of the vehicle driver; and
changing an attribute of the XR item or additionally generating warning content based on the detected information on the eye focus of the vehicle driver.

10. The method of claim 9, wherein the attribute of the XR item includes at least one of a size, a color, a transparency, and a position of the XR item and whether or not the XR item flickers.

11. A smart device comprising:
a processor configured to receive state information of a vehicle driver from a sensor located on a front side of the smart device, to receive a first image of an external environment of a vehicle from a sensor located on a rear side of the smart device, to generate an XR item based on the state information of the vehicle driver, and to output XR content including a second image in which the generated XR item is displayed on the first image;
a memory configured to store at least one of the state information of the vehicle driver, the first image, the XR item, the second image, and the XR content; and
a communication unit connected to the processor to perform transmission and reception of a signal between the vehicle and the processor.

12. The smart device of claim 11, wherein the processor generates the XR item based on an estimated driving route of the vehicle when the estimated driving route is input, and
wherein the estimated driving route of the vehicle is generated by the smart device or is received from the vehicle.

13. The smart device of claim 11, wherein the processor selects a sensor that acquires the first image from among a plurality of sensors based on the state information of the vehicle driver before receiving the first image when the sensor located on the rear side of the smart device is provided in a plural number.

14. The smart device of claim 13, wherein the processor determines whether or not a gaze of the vehicle driver is directed to a first side based on the state information of the vehicle driver when selecting the sensor that acquires the first image, and selects a second lens as the sensor that acquires the first image from among the plurality of sensors located on the rear side of the smart device based on a result of the determination.

15. The smart device of claim 11, wherein the processor receives information on an internal environment of the vehicle from the vehicle, and generates the XR item based on the received information on the internal environment of the vehicle.

16. The smart device of claim 11, wherein the processor outputs the second image to at least one of a display of the smart device and a display of the vehicle.

17. The smart device of claim 16, wherein the processor updates the XR item based on an input by the vehicle driver when the input by the vehicle driver is received from the smart device or the vehicle, and outputs a third image including the updated XR item to one of the smart device and the vehicle from which no input is received.

18. The smart device of claim 11, wherein the state information of the vehicle driver is information acquired by tracing pupils of the vehicle driver.

19. The smart device of claim 11, wherein the processor detects information on an eye focus of the vehicle driver based on the state information of the vehicle driver, and changes an attribute of the XR item or additionally generates warning content based on the detected information on the eye focus of the vehicle driver.

20. A computer readable recording medium in which a method for executing the method of claim 1 in a computer is recorded.
